(19) United States
(12) Patent Application Publication
(10) Pub. No.: US 2004/0111894 A1
(43) Pub. Date: Jun. 17, 2004

(54) Device for trimming candles

(76) Inventor: Clifford Bousada, Cowansville (CA)

Correspondence Address: Eric Fincham, 316 Knowlton Road, Lac Brome, QC, JOE 1VO, CA

(21) Appl. No.: 10/317,628

(22) Filed: Dec. 12, 2002

(51) Int. Cl. A21C 5/00

(52) U.S. Cl. 30/116

(57) ABSTRACT

A device for trimming candles which have burnt and left an upwardly extending rim portion, the device comprising, in one embodiment, a housing, a blade assembly mounted thereon and at least one blade member in the blade assembly, the blade being movable between first and second positions so as to trim wax from the upwardly extending rim portion.

### FIELD OF THE INVENTION

The present invention relates to a candle trimmer and more particularly, relates to a device for trimming the wax ends of candles.

### BACKGROUND OF THE INVENTION

The number of candles sold over the past few years has increased greatly as they have gained status as a decorative item. As such, there is a far greater variety of candles now available than what previously existed. In particular, candles having a relatively large diameter are very popular. However, a problem which exists with such candles is that the burning is uneven with an outer unburned rim portion surrounding an inner portion which has been used as a fuel. As a result, the appearance is frequently deemed to be unattractive.

To date, the only method known to Applicant of attempting to rectify the appearance of the candle has been to use a sharp device such as a knife or a razor blade to remove the outer rim. This is extremely difficult to accomplish by hand and often a ragged uneven appearance results.

A further disadvantage of attempting to trim the upstanding unburned rim portion surrounding the central portion is the safety factor. The wax forming the upstanding rim can be relatively hard and a sharp knife is required. Naturally, slippage is possible and severe injury can result.

### SUMMARY OF THE INVENTION

It is an object of the present invention to provide a device for trimming candles and in particular, for trimming candles having an unburned rim portion.

It is a further object of the present invention to provide a candle trimmer which is both easy to use and relatively inexpensive to manufacture.

According to one aspect of the present invention, there is provided a device for trimming candles wherein the candles have an upwardly extending rim portion, the device comprising a housing, a blade assembly mounted to the housing, and the blade assembly including at least one blade, the at least one blade being movable between first and second positions, the arrangement being such that when the device is placed in position on a candle having an upwardly extending rim, and when the blade is moved from the first position to the second position, the at least one blade is operative to remove wax from the upwardly extending rim.

In a further aspect of the present invention, there is provided a device for trimming a candle, the device having a relatively thin filament, the ends of the filament being connected such that the filament can form a loop about a candle. Actuating means are provided to tighten the filament such that it will be drawn to the candle. Preferably, clamp members are provided for supporting the candle.

Preferably, according to the first embodiment of the present invention, the housing has a generally dome shaped configuration with a generally frustraconical side wall terminating in an annular generally cylindrical skirt. The skirt does not extend through 360° for reasons which will be discussed hereinbelow.

Conveniently, the housing may be molded of a plastic material and may have ridges or other like gripping surfaces formed on an exterior surface thereof.

The blade assembly is designed to be retained by the housing. To this end, there may be provided different means such as a groove within the annular skirt. In a preferred embodiment, there are provided a plurality of tab members which are designed to retain the blade assembly in a desired position during operation but which will also permit the ready removal of the blade assembly for purposes of accessing wax material which has been removed from the candle.

As aforementioned, the blade assembly is preferably retained by the housing in a desired position whereby at least one blade extends substantially horizontally. The blade assembly is movable from a first position to a second position by rotation within the housing such that a blade on the blade assembly will trim the upstanding unburned rim on the candle. In this respect, a number of different blades may be provided and they may be positioned according to the size of the candle to be trimmed.

Separate blade members such as metallic knives may be integrated into the blade assembly which is preferably in the form of a generally circular disk. Alternatively, by utilizing sufficiently hard plastic material, the blade may be formed intrically as a portion of the disk.

Preferably, there is provided an actuating means for turning the blade assembly to thereby remove the upstanding wax rim. Such actuating means may comprise a portion of the disk which extends exteriorly of the housing. To this end, the rim of the housing may include either a gap or an aperture formed therein to permit the actuating member to extend outwardly of the housing.

The device also preferably includes positioning means which are designed to hold the device in a fixed position with respect to the candle while the blade assembly is moved from the first position to the second position. To this end, the positioning member may include a shaft mounted centrally of the housing and about which the blade assembly rotates. The positioning member may have teeth at one end thereof to dig into the wax of the candle and prevent rotation of the housing to which the positioning member is secured.

### BRIEF DESCRIPTION OF THE DRAWINGS

Having thus generally described the invention, reference will be made to the accompanying drawings illustrating embodiments thereof, in which:

FIG. 1 is a top plan view of a candle trimmer according to one embodiment of the present invention;

FIG. 2 is a side elevational view thereof;

FIG. 3 is a bottom plan view thereof;

FIG. 4 is a side elevational view showing views of the device with a smaller candle compared to the embodiment of FIG. 2;

FIG. 5 is a top plan view of a candle trimming device according to a further embodiment of the present invention;

FIG. 6 is a side elevational view thereof;

FIG. 7 is a cross sectional view thereof;

FIG. 8 is a side elevational view, partially in section, of the cover portion of the candle trimming device;

FIG. 9 is a top plan view of the blade assembly of the candle trimming device;

FIG. 9A is a cross sectional view taken along the lines X-X of FIG. 9;

FIG. 10 is a bottom view of the cover portion;

FIG. 11 is a detailed sectional view illustrating the retaining tabs of the cover portion; and

FIGS. 12 and 12A illustrate the use of the device.

### DETAILED DESCRIPTION OF THE EMBODIMENTS

Referring to the drawings in greater detail and by reference characters thereto, there is illustrated in FIG. 2 a first embodiment of a candle trimmer which is generally designated by reference numeral 10.

Candle trimmer 10 has a body portion 14 and a handle portion 12. Mounted at a distal end of body portion 14 are a first clamp 16 and a second clamp 18. Each of clamps 16 and 18 are arcuate in nature to conform, in a general manner, to the surface configuration of a circular candle.

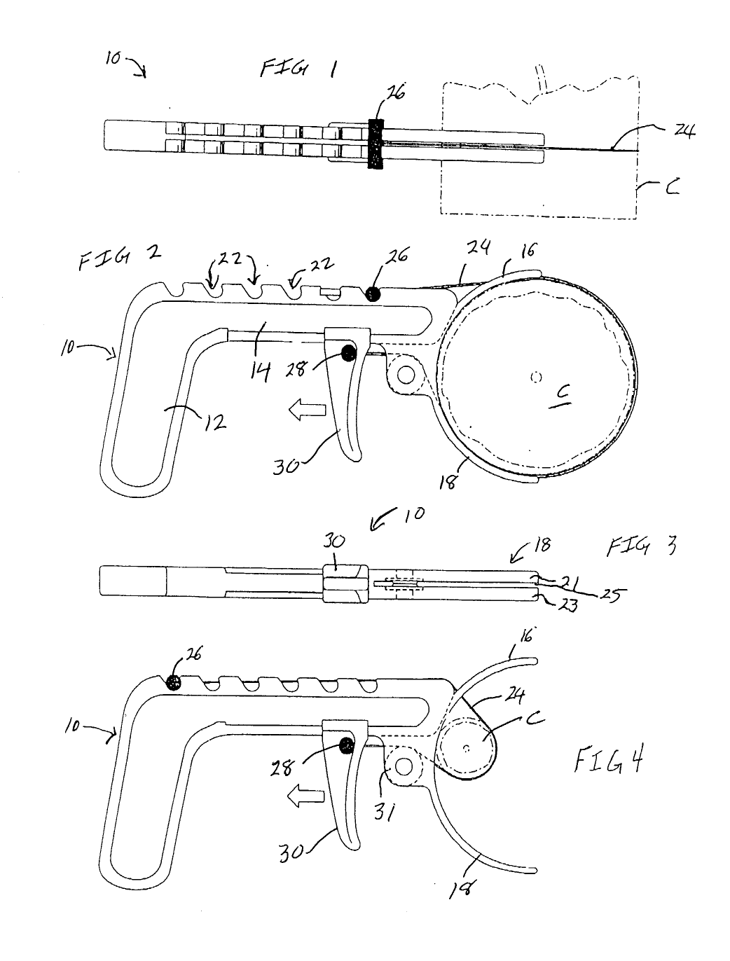

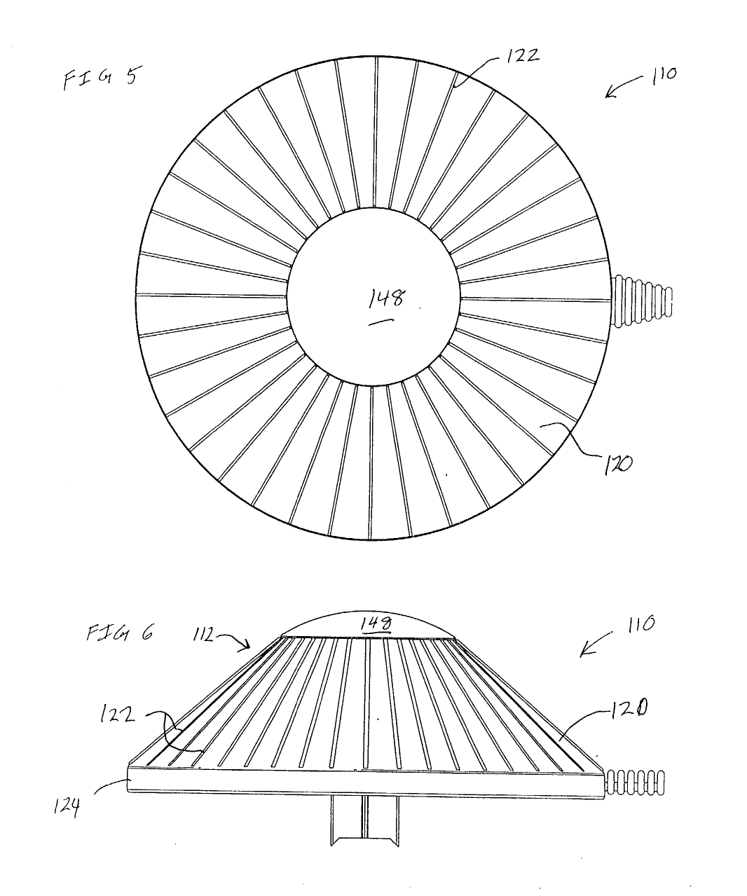

Preferably, although not shown, both first clamp 16 and second clamp 18 are pivotally connected, proximate their center point, to body portion 12. Thus, the clamps would be able to move about their pivot point and securely grasp different size candles. As seen in FIG. 3, clamp 18 has an upper section 21 and a lower section 23 with a recess 25 therebetween. Clamp 16 is of a similar construction.

Formed in the upper wall of body portion 14 are a plurality of notches generally designated by reference numeral 22.

Candle trimmer 10 also includes a cutting filament generally designated by reference numeral 24 and which may be of any suitable material—preferably of a metallic wire material. At either end, cutting filament 24 is provided with enlarged portions 26 and 28.

Depending from body portion 14 and mounted so as to be movable therealong is a trigger 30.

In operation, a first enlarged portion 26 is placed in one of the notches 22. The cutting filament 24 is then looped about a candle C, shown in FIG. 2, and the second enlarged portion 28 placed in a receiving area of trigger 30 with filament 24 passing around guide wheel 31. Trigger 30 is then pulled as shown by the arrow in FIG. 2 and pressure is then exerted on cutting filament 24 such that it will pass through candle C to remove excess wax. Thus, as may be seen, there is provided an inexpensive candle trimmer which is adapted for different sizes of candles. The groove in the clamps 16 and 18 permits the passing of the filament therethrough.

In a further variation of this embodiment of the invention, there may be provided means for heating filament 24. This would be particularly useful when the candle is cold and would ensure a smooth passage of the filament therethrough. Various different types of heating means including electrical resistance heating may be utilized.

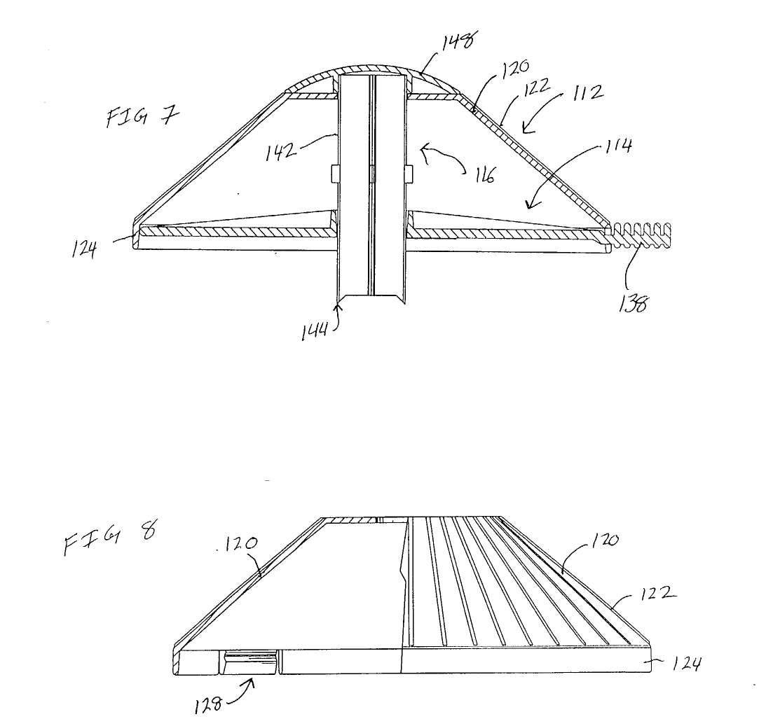

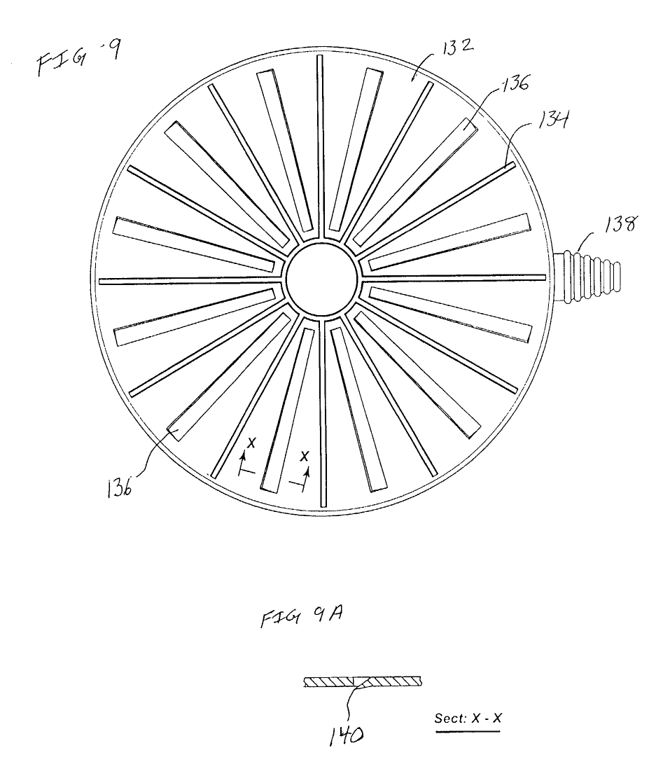

Turning to the embodiment illustrated in FIGS. 5 to 11, there is provided a candle trimming device which is generally designated by reference numeral 110.

Candle trimming device 110 includes a housing generally designated by reference numeral 112, a blade assembly generally designated by reference numeral 114, and a positioning means generally designated by reference numeral 116.

Housing 112, as may be seen in FIGS. 6, 7 and 8, has a frustraconical side wall 120 having a plurality of ridges 122 formed thereon for purposes of gripping. At its lower end, side wall 120 is provided with an annular skirt 124. At the opposite end, side wall 120 terminates to provide an open top 126. Also, as may be seen in FIG. 10, there are a plurality of retainer tabs 128 formed in annular skirt 124, there being three such retainer tabs in the illustrated embodiment.

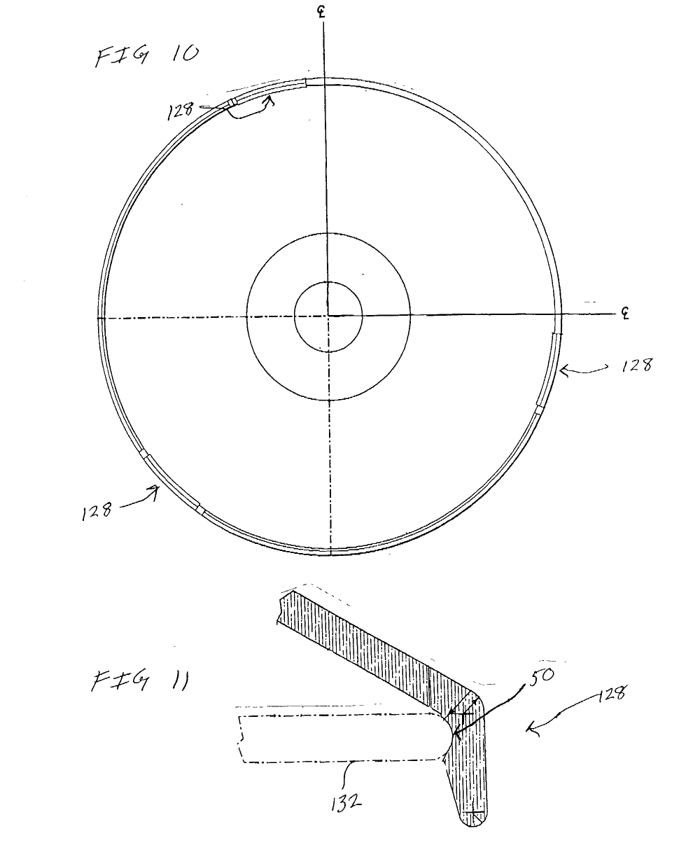

Blade assembly 114 has the form of an annular disk 132 with a plurality of reinforcing ribs 134 extending radially thereof. A plurality of blades 136 are formed in disk 132 and extends slightly downwardly therefrom to provide a cutting edge 140 as may be seen in FIG. 9A. An actuator 138 extends outwardly from disk 132 and as may be seen in FIG. 10, there is provided an approximately 90° portion of housing 112 wherein there is not provided an annular skirt to thereby permit movement of actuator 138.

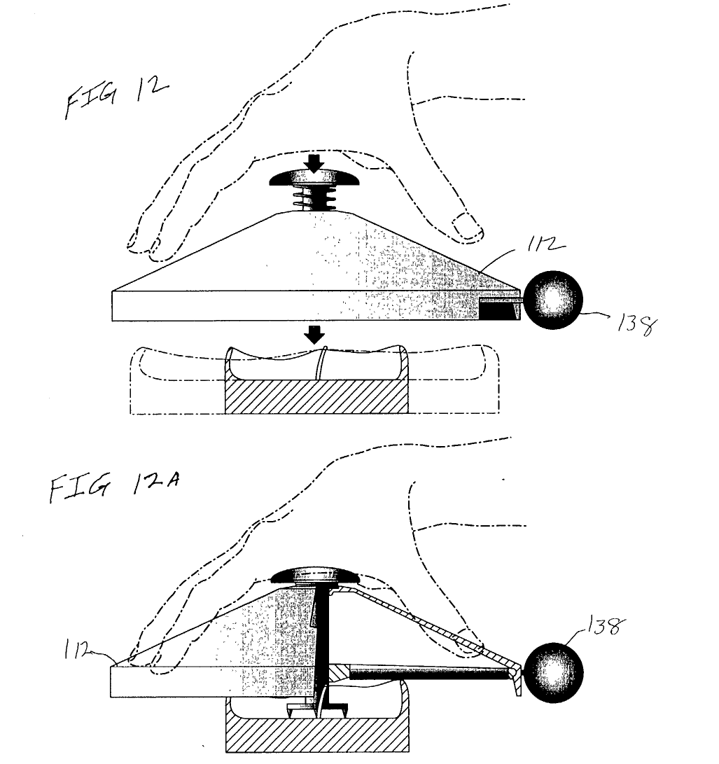

A positioning means 116 comprises a shaft 142, one end of which fits within a cap 148 while at the opposite end, there is provided a seating edge 144 designed to seat in the wax of the candle. As may be best seen in FIG. 11, each retaining tab 128 has an inner recess 150 which is designed to receive the outer edge of disk 132 and retain the same therein while permitting rotational movement thereof.

As may be seen in FIGS. 12 and 12A, the housing 112 may be placed on the candle and actuator 138 operated to rotatably move disc 122 and thereby trim the outer rim of the candle.

It will be understood that the above described embodiments are for purposes of illustration only and that changes or modifications may be made thereto without departing from the spirit and scope of the invention.

I claim:

1. A device for trimming candles, and wherein said candles have an upwardly extending rim portion, said device comprising:
a housing;
a blade assembly mounted to said housing; and
said blade assembly including at least one blade, said at least one blade being movable between first and second positions, the arrangement being such that when said device is placed in position on a candle having an upwardly extending rim, and when said blade is moved from said first position to said second position, said at least one blade is operative to remove wax from said upwardly extending rim portion.

2. The device of claim 1 wherein said device includes positioning means designed to hold said device in a fixed position while said at least one blade is moved from said first position to said second position.

3. The device of claim 2 wherein said blade assembly includes a plurality of blades.

4. The device of claim 3 wherein said blade assembly comprises a disk shaped member having a plurality of radially extending blades.

5. The device of claim 4 wherein said disk shaped member has an actuating member connected thereto, said actuating member extending exteriorly of said housing.

6. The device of claim 4 wherein said disk shaped member is formed of a plastic material, said blades also being of a plastic material.

7. The device of claim 2 wherein said positioning means comprises a centrally located shaft extending downwardly from said housing, and said shaft having means located at the end thereof to abut said candle and prevent rotational movement of said housing.

8. The device of claim 4 wherein said housing has means on an interior surface thereof to retain said disk shaped member.

9. The device of claim 8 wherein said housing has an overall dome shaped configuration with a downwardly extending skirt at a periphery thereof, said downwardly extending skirt including said means for retaining said disk.

10. The device of claim 9 wherein said skirt includes a plurality of tab members formed therein, said tab members being designed to removably retain said disk shaped member.

11. A device for trimming candles, said device comprising a housing, a thin filament, and actuating means for tightening the filament to draw said filament through a candle.
